(19) United States
(12) Patent Application Publication
(10) Pub. No.: US 2025/0378493 A1
(43) Pub. Date: Dec. 11, 2025

(54) DEVICE AND METHOD FOR AUTOMATICALLY PERFORMING REAL ESTATE TRANSACTION

(71) Applicant: KOREA E-CREDIT TECHNOLOGY CO.,LTD., Seoul (KR)

(72) Inventors: Young Sik CHOI, Gangwon-do (KR); Jeong Geun CHOI, Seoul (KR)

(21) Appl. No.: 18/833,863

(22) PCT Filed: Jan. 25, 2023
(86) PCT No.: PCT/KR2023/001129

§ 371 Date: Feb. 14, 2025

(30) Foreign Application Priority Data
Jan. 28, 2022 (KR) 10-2022-0013749

(51) Int. Cl. G06Q 40/04; G06Q 50/16

(52) U.S. Cl. CPC G06Q 40/04; G06Q 50/16

(57) ABSTRACT

There is provided a real estate automatic trading device including a sell order receiving unit configured to receive a sell order for a target real estate including a selection of one of order execution rules of the target real estate from a seller terminal, an order price receiving unit configured to receive a plurality of ask prices from a plurality of sale proposal terminals for the target real estate according to the selected order execution rule, receive a plurality of bid prices from a plurality of buyer terminals, and store the plurality of ask prices and the plurality of bid prices as an order price for the target real estate, and an order execution unit configured to generate order execution information including an order execution counterparty and an order execution price for the target real estate based on the plurality of ask prices and the plurality of bid prices.

### TECHNICAL FIELD

The present disclosure relates to method and apparatus for automatically trading real estate.

### BACKGROUND

The subject of real estate trading is heterogeneous by asset, making it difficult to accurately and objectively estimate real estate value, and there is no unified central exchange like the stock market, making it difficult to systematically collect information and capture real-time prices.

The real estate market structure is largely dependent on certified real estate agents, which makes it difficult to objectively collect real estate information. When an ordinary individual wants to purchase or lease real estate, he or she has to look around several places with a certified real estate agent, compare property prices, and go through the process of selecting a real estate, which is inconvenient because he or she has to directly negotiate with the other party.

Currently, as a non-face-to-face consumption culture spreads due to the spread of COVID-19, the real estate market is rapidly shifting from offline to online, and a Proptech (Property Technology) industry utilizing IT technology is developing rapidly.

However, the chronic problems that have existed in the existing real estate trading market have not been fundamentally resolved, and there is still a problem that inconveniences to buyers are still present. Most of these Proptech business models are focused on advertisements, which are property information, and there is still no online real estate automatic trading system that certified real estate agents and buyers actually need.

### DISCLOSURE

### Technical Problem

A main object of the present disclosure is to minimize complicated trading procedures and inconvenient face-to-face negotiations in real estate trading. In addition, an object of the present disclosure is to realize convenient trading and save time and money by allowing the trading parties to directly participate in the trading through transparent procedures, thereby enabling trading through simple trading procedures.

### SUMMARY

According to the present embodiment, there is provided a real estate automatic trading device including: a sell order receiving unit configured to receive a sell order for a target real estate including a selection of one of order execution rules of the target real estate from a seller terminal; an order price receiving unit configured to receive a plurality of ask prices from a plurality of sale proposal terminals for the target real estate according to the selected order execution rule, receive a plurality of bid prices from a plurality of buyer terminals wishing to purchase the target real estate, and store the plurality of ask prices and the plurality of bid prices as an order price for the target real estate; and an order execution unit configured to generate order execution information including an order execution counterparty and an order execution price for the target real estate based on the plurality of ask prices and the plurality of bid prices.

According to the present embodiment, there is provided a method of executing real estate automatic trading by a real estate automatic trading (transaction) device, the method including: receiving a sell order for a target real estate including a selection of one of order execution rules of the target real estate from a seller terminal; receiving a plurality of ask prices from a plurality of sale proposal terminals for the target real estate according to the selected order execution rule, receiving a plurality of bid prices from a plurality of buyer terminals wishing to purchase the target real estate, and storing the plurality of ask prices and the plurality of bid prices as an order price for the target real estate; and generating order execution information including an order execution counterparty and an order execution price for the target real estate based on the plurality of ask prices and the plurality of bid prices.

### Advantageous Effects

The present disclosure has the effect of minimizing complicated trading procedures and inconvenient face-to-face negotiations during real estate trading. In addition, by allowing the trading parties to directly participate in the trading through transparent procedures, it has the effect of generating a fair real estate trading environment and greatly contributing to the stabilization of the real estate market.

According to the present disclosure, sellers or landlords can easily place a sale order, and buyers or tenants can simply search for the desired real estate and transact through a simple trading procedure, which is convenient and saves time and money.

When using the system provided by the present disclosure, certified real estate agents can easily identify customers with a high willingness to execution by allowing consumers to directly input, confirm, and revise an order price, and it is possible to realize a low-cost and high-efficiency brokerage service that saves communication time and cost between certified real estate agents and customers and increases the transaction success rate.

The present disclosure can be usefully applied to asset transaction matching platforms that have the characteristics of registering or extinguishing hundreds of thousands of online real-time trading targets, such as intellectual property rights transactions and NFT transactions, by providing an environment that provides price adjustments and automatic trading executions on an online trading platform instead of the existing offline price negotiation method.

The present disclosure system is easy to apply because it takes a short time to expand the infrastructure when installed in a cloud environment that does not require expansion or new installation of IT infrastructure, and it has the effect of activating trading by grafting a competitive trading method matching service onto an asset trading platform where consumers can freely register and delete trading targets online.

### BRIEF DESCRIPTION OF THE DRAWINGS

FIG. 1 is an exemplary function block diagram of a real estate automatic trading device according to the present embodiment.

FIG. 2 is a drawing illustrating a physical configuration of the real estate automatic trading device.

FIG. 3 is a drawing illustrating the configuration of an execution server 220.

FIG. 4 is a drawing illustrating the configuration of a price server 230.

FIG. 5 is a drawing illustrating a case where a plurality of independent execution units 220a, 220b, and 220c are generated within an execution server 220 to improve simultaneous processing capabilities.

FIG. 6 is a drawing illustrating a smartphone screen for using a real estate automatic trading device 100.

FIG. 7 is an exemplary flow chart of a real estate automatic trading method according to the present embodiment.

### DETAILED DESCRIPTION

Hereinafter, some embodiments of the present disclosure will be described in detail through exemplary drawings. When adding identification symbols to components of each drawing, it should be noted that the same components are given the same symbols as much as possible even when they are displayed on different drawings. In addition, when describing the present disclosure, when it is determined that a specific description of a related public notice configuration or function may obscure the gist of the present disclosure, the detailed description is omitted.

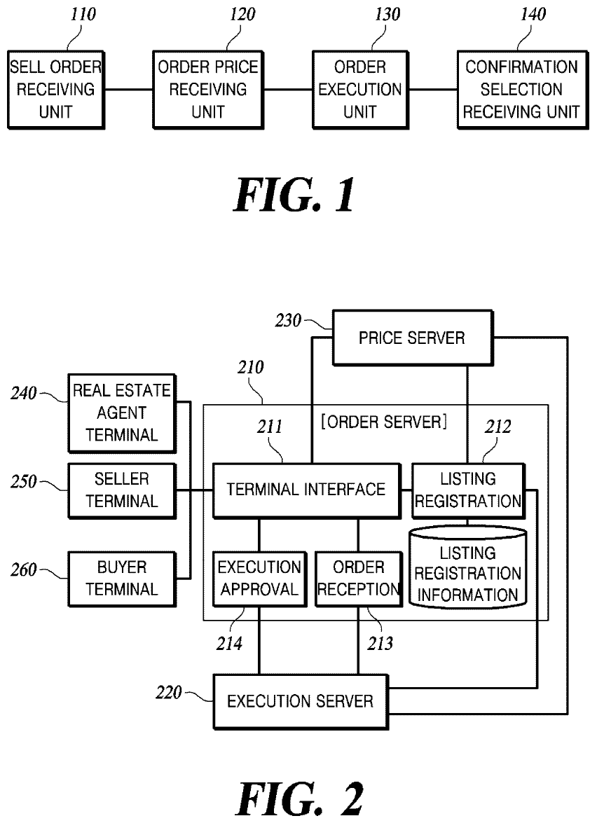

FIG. 1 is an exemplary function block diagram of a real estate automatic trading (transaction) device according to the present embodiment.

The real estate automatic trading device 100 may be configured to include a sell order receiving unit 110, an order price receiving unit 120, an order execution unit 130, and a confirmation selection receiving unit 140.

Each component of the real estate automatic trading device 100 may be implemented as hardware or software, or may be implemented as a combination of hardware and software. In addition, the function of each component may be implemented as software, and a microprocessor may be implemented to execute a function of the software corresponding to each component.

FIG. 2 is a drawing illustrating a physical configuration of the real estate automatic trading device.

The real estate automatic trading device 100 may be configured to include an order server 210, an execution server 220, a price server 230, a certified real estate agent terminal 240, a seller terminal 250, and a buyer terminal 260, and the order server 210 may be configured to include a terminal interface 211, a listing registration module 212, an order reception module 213, and an execution approval module 214.

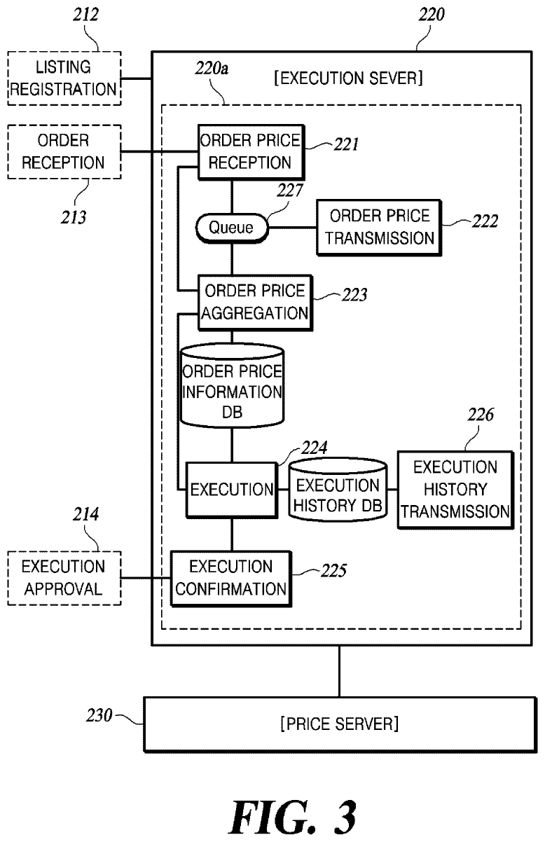

FIG. 3 is a drawing illustrating the configuration of the execution server 220.

The execution server 220 may be implemented to include one or more execution units 220a.

The execution unit 220a may be configured to include an order price reception module 221, an order price transmission module 222, an order price aggregation module 223, an execution module 224, an execution confirmation module 225, and an executions history transmission module 226.

Meanwhile, the function of the sell order receiving unit 110 may be implemented as the listing registration module 212, the order price receiving unit 120 may be implemented as the order reception module 213, and the confirmation selection receiving unit 140 may be implemented as the execution approval module 214.

In addition, the function of the order execution unit 130 may be implemented as the execution server 220.

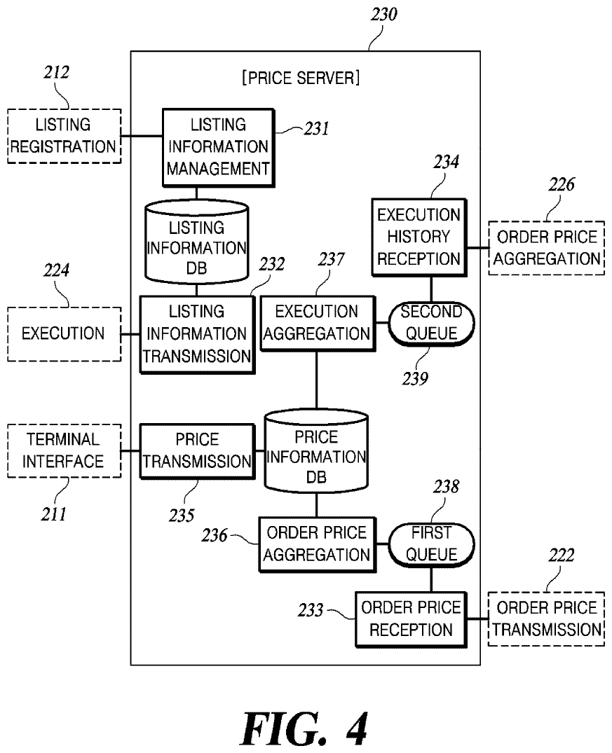

FIG. 4 is a drawing illustrating the configuration of a price server 230.

The price server 230 may be configured to include a listing information management module 231, a listing information transmission module 232, an order price reception module 233, an executions history reception module 234, a price transmission module 235, an order price aggregation module 236, and an execution aggregation module 237.

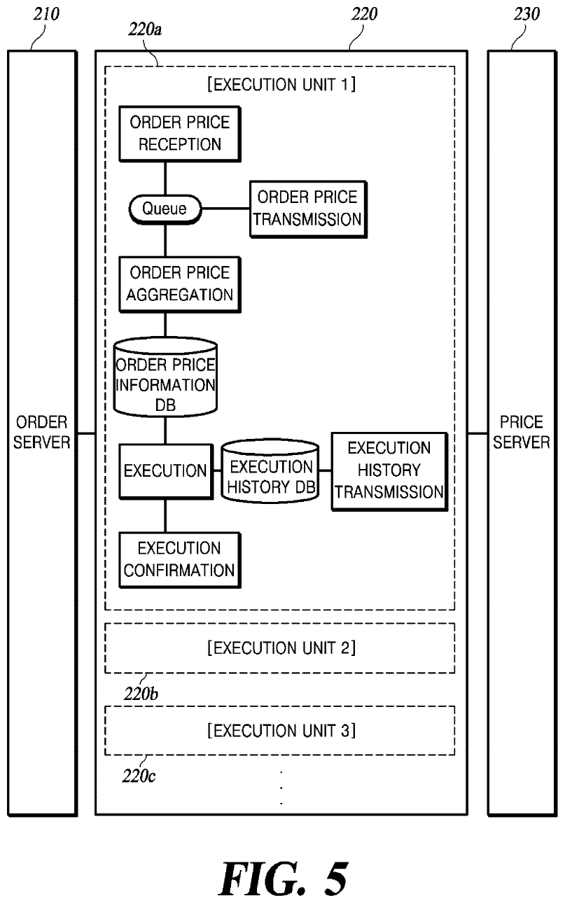

FIG. 5 is a drawing illustrating a case where a plurality of independent execution units 220a, 220b, and 220c are configured within the execution server 220 to improve simultaneous processing capability.

The execution units 220a, 220b, and 220c within the execution server 220 may be generated and configured by the order server 210.

Hereinafter, the function of the real estate automatic trading device 100 will be described with reference to FIGS. 1 to 5 together.

The listing registration module 212 receives a sell order from the seller, which includes a selection of one of the order execution rules of the target real estate. Here, the seller may be a real estate seller using a seller terminal 250, and the buyer may be a real estate buyer using the certified real estate agent terminal 240 or the buyer terminal 260.

The certified real estate agent terminal 240 is a hardware or program, such as a mobile app or a WEB or a module that provides a similar function, through which a certified real estate agent registers as a member of the real estate automatic trading device 100 and connects to the order server 210 to transmit or receive information (that is, ask price) related to a sale proposal for the target real estate. Hereinafter, the certified real estate agent terminal 240 may be referred to as a sale proposal terminal.

The seller terminal 250 is a hardware or program such as a mobile app, a WEB, or a module providing similar functions that allows a real estate seller to register as a member of the real estate automatic trading device 100 or to connect to the order server 210 without registering as a member and transmit or receive information related to the sale of the target real estate.

The buyer terminal 260 is a hardware or program such as a mobile app, a WEB, or a module providing similar functions that allows a real estate buyer to register as a member of the real estate automatic trading device 100 or to connect to the order server 210 without registering as a member and transmit or receive information (that is, bid price) related to the purchase of the target real estate.

The seller terminal 250 connects to the terminal interface 211 of the order server 210 and transmits a sell order of the target real estate including a selection of one of the order execution rules of the target real estate to the listing registration module 212.

The certified real estate agent terminal 240 may perform the same function as the sell order transmission function of the seller terminal 250.

When the listing registration module 212 receives a sell order from the seller terminal 250, the listing registration module generates listing information including a new listing unique identification number and synchronously transmits the new listing information to the listing information management module 231.

The seller terminal 250 may transmit new listing information to the listing registration module 212 using the mobile application function or the Internet WEB function provided by the order server 210 to the seller terminal 250. When the seller terminal 250 transmits new listing information to the listing registration module 212, the listing registration module 212 transmits a command to the execution server 220 to generate a new execution units 220a, 220b, and 220c.

When the execution server 220 receives an execution unit generation command from the listing registration module 212, the execution server may generate a new execution unit 220b in real time without interference from the existing execution unit 220a.

When the listing registration module 212 transmits new listing information to the listing information management module 231, the listing information management module 231 stores the listing information in the price server 230.

When a seller registers a listing using the seller terminal 250, a plurality of order execution rules provided by the listing registration module 212 may include a first execution rule, a second execution rule, a third execution rule, and a fourth execution rule, and one of the first execution rule, the second execution rule, the third execution rule, and the fourth execution rule may be selected.

The first execution rule is a rule (that is, simultaneous order price execution method) for concluding a sale of a target real estate by inputting one or more bid prices (that is, desired purchase order prices) and one or more ask prices (that is, proposed order prices) for the target real estate during a predetermined period without setting a reference price, the second execution rule is a rule (that is, connection order price execution method) for concluding a sale of a target real estate by inputting one or more bid prices and one or more ask prices for the target real estate based on the reference price, the third execution rule is a rule (that is, auction execution method) for concluding a sale by inputting one or more bid prices for the target real estate, and the fourth execution rule is a rule (that is, designation price execution method) for concluding a sale of a target real estate by inputting one or more bid prices based on a designated price for the target real estate.

Here, the ask price is a proposed order price input from a sale proposal terminal (that is, a certified real estate agent terminal 240), and the proposed order price means an order price proposed to a seller for selling a real estate registered as a listing. Therefore, a plurality of ask prices may be input by a plurality of certified real estate agent terminals 240 for each real estate listing information.

The respective operations of the real estate automatic trading device 100 according to the above four execution rules are as follows.

### 1. First Execution Rule (Simultaneous Order Price Execution Method)

When the seller terminal 250 calls the listing registration module 212 to select the first execution rule from among the plurality of order execution rules and registers the target real estate listing, the listing registration module 212 stores listing registration information including the listing information entered by the seller terminal 250 and the first execution rule selection information. The listing registration module 212 transmits the listing registration information to the execution server 220. When the execution server 220 receives listing registration information, the execution server generates the corresponding execution unit 220a, and the execution unit 220a is set to operate according to the first execution rule.

When the first execution rule is selected, a designated period for receiving one or more bid prices and one or more ask prices for the target real estate may be set by the seller terminal 250. The set designated period may be included in the listing registration information.

After the listing registration for the target real estate is completed by the listing registration module 212, the order reception module 213 may receive ask prices for the target real estate from the plurality of certified real estate agent terminals 240 connected to the terminal interface 211, and at the same time, may receive bid prices for the target real estate from the plurality of buyer terminals 260.

The certified real estate agent terminal 240 or the seller terminal 250 may select whether to disclose the ask price. When the seller terminal 250 or the certified real estate agent terminal 240 is set not to disclose the ask price, the terminal interface 211 may not transmit the order price to the certified real estate agent terminal 240 and the buyer terminal 260. At this time, the certified real estate agent terminal 240 that input the ask price may check the ask price input by the certified real estate agent terminal.

The order reception module 213 transmits each ask price (that is, ask price or bid price) to the order price reception module 221 in the execution unit 220a corresponding to the target real estate.

The order price reception module 221 receives each order price from the order reception module 213 and stores it in the queue 227 in the execution unit 220a in the order of reception.

The order price aggregation module 223 sequentially accesses each order price stored in the queue 227 and stores it in the order price information DB.

The order price transmission module 222 sequentially accesses each order price stored in the queue 227 and transmits the order price to the order price reception module 233 in the price server 230.

The order price reception module 233 receives each order price from the order price transmission module 222 and stores the order price in a first queue 238 in the price server 230 in the order of reception.

The order price aggregation module 236 in the price server 230 sequentially accesses each order price stored in the first queue 238 and stores it in price information DB in the price server 230.

The price transmission module 235 in the price server 230 sequentially accesses the information stored in the price information DB and transmits the information to the terminal interface 211.

After the listing registration related to the target real estate is performed by the listing registration module 212, the order reception module 213 may receive the bid price for the target real estate from the plurality of buyer terminals 260.

The execution unit 220a generates order execution information using the order price information and the designated period of the corresponding target real estate.

The execution module 224 in the execution unit 220a generates order execution information including the ask price and the bid price of the target real estate in the execution unit 220a when the designated period has arrived.

The execution module 224 applies a time priority principle to set a price at which the lowest ask price and the highest bid price are matched as the execution price.

For example, it is assumed that there are three sellers S1, S2, and S3, the order price of S1 is 10,200 won, the order price of S2 is 10,100 won, and the order price of S3 is 10,300, and there are three buyers B1, B2, and B3, the order price of B1 is 10,400 won, the order price of B2 is 10,300 won, and the order price of B3 is 10,500 won.

The ask price is determined as an execution counterparty starting with a first-priority seller S2 by sorting the order prices received during the designated period in order of the lowest order price (S2.10100<S1.10200<S3.10300). Also, the bid price is determined by sorting the order prices received during the designated period in order of the highest bid price (B3.10500>B1.10400>B2.10300) and determining the counterparty from the first-priority seller B3. In other words, the counterparty is concluded with the buyer S2 and the seller B3 as the execution counterparties through price priority competition.

In the determination of the execution prices, in the order prices arranged in order of the lowest ask price (S2.10100<S1.10200<S3.10300) and arranged in order of the highest bid price (B3.10500>B1.10400>B2.10300), the order price that is received first of the ask price of S2, which is the price corresponding to the lowest ask price, and the bid price of B3, which is the price corresponding to the highest bid price, becomes the execution price. For example, when S2.10100 is received before B3.10500, 10,100 won which is the ask price of S2 is used as the execution price. When B3.10500 is received before S2.10100, 10,500 won which is the order price of B3 is used as the execution price.

When there are identical prices among the plurality of bid prices received, the person who presented the order price received first in time may be determined as the trading execution counterparty. Even when there are identical prices among the plurality of ask prices received, the person who presented the order price received first in time may be determined as the trading execution counterparty.

The execution module 224 stores the generated order execution information in the executions history DB. The execution confirmation module 225 transmits a message requesting approval of the order execution information to both the seller terminal 250 and the buyer terminal 260 based on the order execution information. Depending on the embodiment, a message requesting approval of order execution information may be transmitted only to the seller terminal 250, or a message requesting approval of order execution information may be transmitted only to the buyer terminal 260.

Information on the buyer or seller who will receive the approval for order execution information can be included and stored in the listing registration information.

When the listing registration information is set to receive approval for the order execution information from both the seller terminal 250 and the buyer terminal 260, the execution confirmation module 225 stores the approved information in the executions history DB as soon as approval is received from each terminal.

The executions history transmission module 226 transmits the executions history stored in the executions history DB to the executions history reception module 234 in the price server 230.

### 2. Second Execution Rule (Connection Order Price Trading Method)

When the seller terminal 250 calls the listing registration module 212 to select the second execution rule from among the plurality of order execution rules and registers the target real estate listing, the listing registration module 212 stores the listing registration information including the listing information input in the seller terminal 250 and the second execution rule selection information. The listing registration module 212 transmits the listing registration information to the execution server 220. When the execution server 220 receives the listing registration information, the execution server generates the corresponding execution unit 220a, and the execution unit 220a is set to operate according to the second execution rule.

When the second execution rule, which is the connection order price execution method, is selected, a reference price for the target real estate is set. In this case, the reference price can be determined based on the actual transaction price of the predetermined period, and the actual transaction price may be transmitted from the Ministry of Land, Infrastructure and Transport server 270. The Ministry of Land, Infrastructure and Transport server 270 provides real estate actual transaction price information upon request from the price server 230.

The price transmission module 235 transmits the actual transaction price received from the Ministry of Land, Infrastructure and Transport server 270 to the execution module 224. The execution module 224 calculates the reference price by referring to the actual transaction price. The reference price produced here may be the previous actual transaction price or the average of the actual transaction prices during the predetermined period.

When the actual transaction price during the predetermined period does not exist, the reference price may be determined by referring to the previous order price for the target real estate. Here, the previous order price may be transmitted from an external server, but the higher price of the highest bid price and the lowest ask price may be selected as the reference price by referring to the bid price or ask price input during the process of generating the order execution information by the first execution rule (simultaneous order price execution method).

Even when the order execution information is generated by the first execution rule (simultaneous order price execution method), it may not lead to an actual execution. In this case, when a contract execution completion message is not received from the seller terminal 250 during the predetermined period, the seller terminal 250 may automatically set the execution price determined in the process of generating the order execution information as a new reference price and ask whether to sell the target real estate as a second execution rule, and the process of selling the target real estate as a second execution rule may be executed based on the confirmation of the seller terminal 250.

In addition, when the a trade execution is attempted based on the first execution rule (simultaneous order price execution method) but the order execution information is not generated during the designated period, the seller terminal 250 may automatically set the bid price or ask price input in the process of attempting to the trade execution based on the first execution rule as the reference price and ask whether to sell the target real estate as a second execution rule, and the process of selling the target real estate as a second execution rule may be executed based on the confirmation of the seller terminal 250.

When the second execution rule is selected, a designated period for receiving one or more bid prices for the target real estate may be set by the seller terminal 250, but may also be set to continuously receive the bid prices and ask prices until the trade execution is realized. The designated period may be included in the listing registration information.

After listing registration related to the target real estate is completed by the listing registration module 212, the order reception module 213 may receive the ask price for the target real estate from one or more certified real estate agent terminals 240.

The order reception module 213 performs suitability verification based on the upper/lower price limit range compared to the reference price set for the target real estate for at least one of the ask price and the bid price. In other words, the bid price and the ask price that are outside the upper/lower price limit range compared to the reference price may be considered as abnormal order prices and implemented so as not to be registered as the order price information. Here, the upper/lower price limit range may be set as a predetermined rate, or may be set by selection of the seller terminal 250.

When one or more certified real estate agent terminals 240 and buyer terminals 260 connected to the terminal interface 211 input the ask price and the bid price for the target real estate, respectively, the order reception module 213 transmits each order price to the order price reception module 221 in the execution unit 220a.

The order price reception module 221 stores each order price in the queue 227 in the execution unit 220a in the order in which the order price is received from the order reception module 213.

The order price aggregation module 223 sequentially accesses each order price stored in the queue 227 and stores the order price in the order price information DB.

The order price transmission module 222 sequentially accesses each order price stored in the queue 227 and transmits the order price to the order price reception module 233 in the price server 230.

The order price reception module 233 stores each order price in the order received from the order price transmission module 222 in the first queue 238 in the price server 230.

The order price aggregation module 236 in the price server 230 sequentially accesses each order price stored in the first queue 238 and stores the order price in the price information DB in the price server 230.

The execution unit 220a generates the order execution information using the order price information and designated period of the corresponding target real estate.

The order price reception module 221 or the order price aggregation module 223 immediately operates the execution module 224 within the execution unit 220a after receiving the order price to check whether the trade execution is realized. In this case, the execution module 224 within the execution unit 220a generates the order execution information including the ask price and the bid price of the target real estate stored in the order price information DB within the execution unit 220a when the designated period has arrived. At this time, the method for determining the execution counterparty and the execution price is the same as the method for generating order execution information by the first execution rule (simultaneous order price execution method).

### 3. Third Execution Rule (Auction Execution Method)

When the seller terminal 250 calls the listing registration module 212 to select the third execution rule from among the plurality of order execution rules and registers the target real estate listing, the seller terminal 250 calls the listing registration module 212 to specify the lowest price and store the listing registration information including the execution rule information. The listing registration module 212 transmits the listing registration information to the execution server 220. When the execution server 220 receives the listing registration information, the execution server generates the corresponding execution unit 220a, and the execution unit 220a is set to operate according to the third execution rule.

When the listing registration module 212 transmits the listing registration information to the execution server 220, the execution unit 220a generated by the execution server 220 receives only the bid price that is higher than the lowest price according to the third execution rule and generates the order execution information.

When the third execution rule is selected, a designated period for receiving one or more bid prices for the target real estate may be set by the seller terminal 250. The set designated period may be included and stored in the listing information.

After the listing registration related to the target real estate is realized by the listing registration module 212, the order reception module 213 can receive the bid price for the target real estate from one or more buyer terminals 260.

The certified real estate agent terminal 240 or the seller terminal 250 may select whether to disclose the ask price. When it is selected not to disclose the ask price, the terminal interface module 211 may not transmit the order price to the certified real estate agent terminal 240 and the buyer terminal 260.

The order reception module 213 may perform the suitability verification to verify whether the input bid price is higher than the lowest price. When the bid price lower than the lowest price is input as a result of the suitability verification, the order reception module 213 transmits the message indicating that the bid price is the abnormal order price to the terminals 240, 250, and 260 and does not transmit the bid price to the execution server 220.

The order reception module 213 transmits each bid price whose suitability has been verified to the order price reception module 221 in the execution unit 220a.

The order price reception module 221 receives the bid price from the order reception module 213 and stores the bid price in the queue 227 in the execution unit 220a in the order of reception.

The order price aggregation module 223 sequentially accesses the bid prices stored in the queue 227 and stores the by order prices in the order price information DB.

The order price transmission module 222 sequentially accesses the bid prices stored in the queue 227 and transmits the by order prices to the order price reception module 233 in the price server 230.

The order price reception module 233 receives the bid prices from the order price transmission module 222 and stores the bid prices in the first queue 238 in the price server 230 in the order of reception.

The order price aggregation module 236 in the price server 230 sequentially accesses the bid prices stored in the first queue 238 and stores the bid prices in the price information DB in the price server 230.

When the designated period has arrived, the execution module 224 of the execution unit 220a generates the order execution information using the order price information of the target real estate. In this case, the execution module 224 selects the bid price with the highest price and generates the order execution information. Therefore, the buyer who input the selected bid price is determined as the buyer and is generated as the order execution information together with the selected bid price.

When the execution module 224 generates order execution information, the execution module stores the order execution information in the executions history DB. The execution confirmation module 225 transmits a message requesting approval of the order execution information to both the seller terminal and the buyer terminal based on the order execution information.

Information on the buyer or seller who will receive the approval of the order execution information may be included and stored in the listing registration information.

When the listing registration information is set to receive the approval of the order execution information from both the seller terminal and the buyer terminal, the execution confirmation module 225 stores the approval information in the executions history DB as soon as approval is received from both parties.

The executions history transmission module 226 transmits the executions history stored in the executions history details DB to the executions history reception module 234 in the price server 230.

When the designated period has arrived but no bid price higher than the lowest price has been received, the execution unit 220a generates the order execution information indicating that the trade execution has not been realized and transmits the information to the order server 210.

When the trade execution has not been realized, the revised ask price can be automatically calculated instead of the lowest price and set as the lowest price to retry the real estate automatic transaction as the third execution rule.

When registering the listing information, the seller may set the ask price to be automatically calculated when the lowest price-based trade execution fails. The calculation of the revised ask price is described in detail in the following fourth execution rule description.

### 4. Fourth Execution Rule (Designation Price Execution Method)

The seller terminal 250 calls the listing registration module 212 to select the fourth execution rule from among the plurality of order execution rules and then registers the target real estate listing. The seller terminal 250 connected to the listing registration module 212 sets the designated period for the target real estate and specifies the ask price to store the listing registration information.

In addition, the listing registration module 212 provides the seller terminal 250 with a function for selecting whether the revised ask price for the target real estate is automatically calculated by the real estate automatic trading device 100.

The order reception module 213 transmits the received ask price (that is, designated price) to the order price reception module 221 in the execution unit 220a.

The listing registration module 212 transmits the listing registration information to the execution server 220. When the execution server 220 receives the listing registration information, the execution server 220 generates a corresponding execution unit 220a, and the execution unit 220a is set to operate according to the fourth execution rule.

When the fourth execution rule is selected, the designated price is set as the reference price for the target real estate.

The order reception module 213 performs the suitability verification based on the upper/lower price limit range compared to the reference price for at least one of the bid prices. That is, the bid price that is outside the upper/lower price limit range compared to the reference price may be considered the abnormal order price and implemented so as not to be registered as order price information. Here, the upper/lower price limit range may be set as a predetermined ratio, and may be set by selection of the seller terminal 250.

When one or more buyer terminals 260 connected to the terminal interface 211 input the bid price for the target real estate, the order reception module 213 transmits each bid price to the order price reception module 221 in the execution unit 220a.

The order price reception module 221 stores the received bid price in the queue 227. The order price reception module 221 stores the same price as the ask price for the target real estate as the bid price in the queue 227 even when receiving a sale intent message.

The order price aggregation module 223 sequentially accesses the bid prices stored in the queue 227 and stores the bid prices in the order price information DB.

The order price transmission module 222 sequentially accesses the bid prices stored in the queue 227 and transmits the bid prices to the order price reception module 233 in the price server 230.

The order price reception module 233 stores the bid prices received from the order price transmission module 222 in the first queue 238 in the price server 230 in the order in which the bid prices are received.

The order price aggregation module 236 in the price server 230 sequentially accesses the bid prices stored in the first queue 238 and stores the bid prices in the price information DB in the price server 230.

The execution unit 220a generates the order execution information including the bid price and the corresponding buyer stored in the order price information DB.

When the execution module 224 generates the order execution information, the execution module stores the order execution information in the executions history DB. The execution confirmation module 225 transmits the message requesting the seller terminal to approve the order execution information based on the order execution information to the execution approval module 214.

When the execution approval module 214 receives the approval message from the seller terminal, the execution approval module 214 transmits the approval message to the execution confirmation module 225, and the execution confirmation module 225 stores the approval information in the executions history DB.

When the bid price is not received until the designated period arrives, the execution module 224 calculates a revised ask price and stores the revised ask price as related information of the target real estate.

In addition, when the bid price is not received until the designated period arrives, the execution confirmation module 225 transmits a message notifying that there is no bid price until the designated period to the execution approval module 214.

When there is no bid price for the target real estate or there is no matching execution price, the execution module 224 may calculate the revised ask price. The execution module 224 may calculate the revised ask price by weighting the previous actual transaction price and the ask price of the target real estate. The weights for weighting the previous actual transaction price and the ask price can have values such as 0.4, 0.5, and 0.6, respectively.

In the case of an apartment, the revised ask price may use the actual transaction price of an apartment of the same size in the same complex. In addition, the actual transaction price of a similar real estate within a certain radius from the location of the target real estate may be referenced.

The execution module 224 calculates the revised ask price and then receives the additionally received bid price from the order reception module 213 during another designated period (that is, the second designated period). When the execution module 224 receives a message that there is an additionally received bid price or that the buyer is willing to buy at the revised ask price, the execution module generates the order execution information with the revised ask price.

Meanwhile, the executions history transmission module 226 transmits the executions history stored in the executions history DB to the executions history reception module 234 in the price server 230.

The executions history reception module 234 stores the executions history in the second queue 239, and the execution aggregation module 237 sequentially acquires the information stored in the second queue 239 and stores the information in the price information DB.

Meanwhile, each of the execution units 220a, 220b, and 220c is generated for each listing unique identification number, and each of the execution units 220a, 220b, and 220c may independently execute each execution module 224 without mutual interference when receiving the order price.

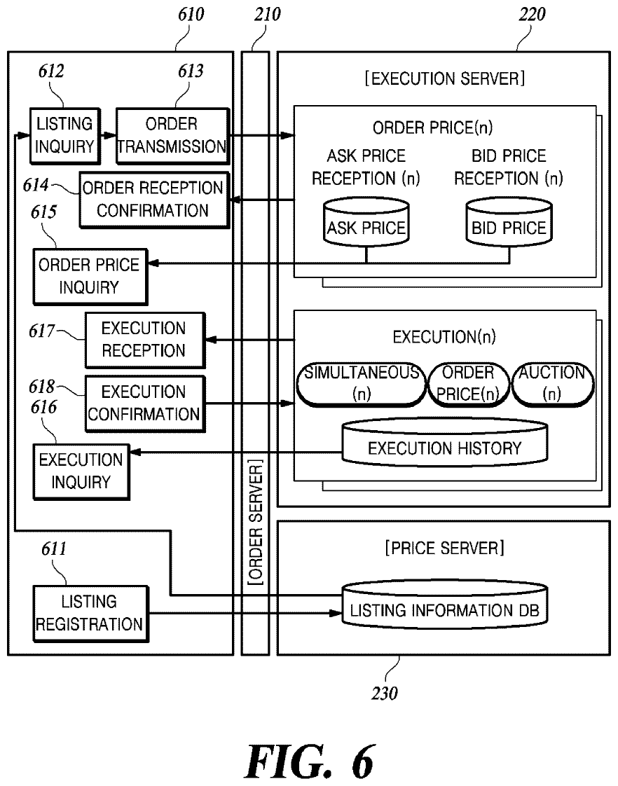

FIG. 6 is a drawing illustrating an example of a smartphone screen for using the real estate automatic trading device 100.

In FIG. 6, communication between the smartphone screen 610 and the execution server 220 may be operated via the order server 210.

When listing registration 611 is pressed on the smartphone screen 610 illustrated in FIG. 6, the listing information and execution rules are entered on the smartphone screen and then stored in the listing information DB of the price server 230.

When listing inquiry 612 is pressed on the screen 610, the smartphone is connected to the price server 230 and the listing information stored in the listing information DB may be searched and displayed on the smartphone.

When the listing inquiry 612 is pressed and then order transmission 613 is pressed, a screen for inputting the bid price or ask price as the order price is displayed on the screen, and the bid price or ask price is input on the screen, the input information is stored as the bid price information or the ask price information in the order price information DB of the execution server 220, and a message related to the order reception confirmation 614 is received from the execution server 220.

When order price inquiry 615 is pressed on the screen 610, the bid price information or the ask price information stored in the order price information DB is transmitted from the execution server 230 and displayed on the screen.

When listing inquiry 616 is pressed, the corresponding executions history stored in the execution DB in the execution server 220 is searched.

When the order execution information is received from the execution server 220, the contents of the order execution information may be received and confirmed by pressing an execution reception 617 button, and information on approval/rejection of the order execution information is transmitted to the execution server 220 by pressing the execution confirmation 618.

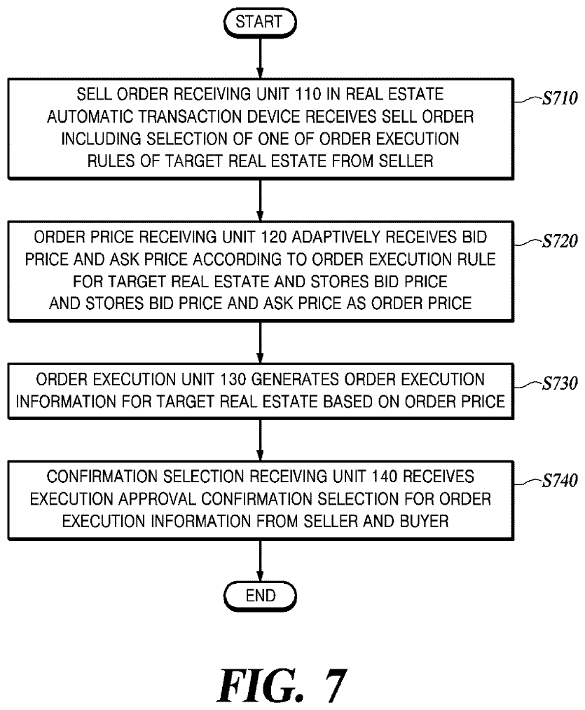

FIG. 7 is an exemplary flow chart of a real estate automatic trading method according to the present embodiment.

The sell order receiving unit 110 in the real estate automatic trading device 100 receives the sell order including a selection of one of the order execution rules of the target real estate from the seller (S710).

The order price receiving unit 120 receives the bid price and ask price according to the order execution rule for the target real estate and stores the bid price and ask price as the order price for the target real estate (S720).

The order execution unit 130 generates the order execution information for the target real estate based on the order price (S730).

The confirmation selection receiving unit 140 receives an execution approval confirmation selection for the order execution information from the seller and the buyer (S740).

Since the processes of S710 to S740 have been described in detail in the description of the real estate automatic trading device 100, further detailed descriptions are omitted.

It should be understood that in the above description, the term “real estate sale” may include real estate sale acts, real estate rentals, and similar acts, and the term “real estate purchase” may also include real estate purchase acts, real estate leases, and similar acts.

Meanwhile, various functions or methods described in the present disclosure may be implemented as commands stored in a non-transitory storage medium that can be read and executed by one or more processors. The non-transitory storage medium includes, for example, all types of storage devices in which data is stored in a form readable by a computer system. For example, the non-transitory storage medium includes storage media such as EPROM (Erasable Programmable Read Only Memory), flash drives, optical drives, magnetic hard drives, and solid state drives (SSDs).

It should be understood that the exemplary embodiments described above can be implemented in many different ways. The functions described in one or more examples can be implemented in hardware, software, firmware, or any combination thereof. It should be understood that the functional components described herein are labeled as “units” to particularly emphasize their implementation independence.

The above description is merely an exemplary description of the technical idea of the present embodiment, and those skilled in the art to which the present embodiment belongs can make various modifications and variations without departing from the essential characteristics of the present embodiment. Accordingly, the present embodiments are intended to explain, not limit, the technical idea of the present embodiment, and the scope of the technical idea of the present embodiment is not limited by these embodiments. The scope of protection of the present embodiment should be interpreted by the claims below, and all technical ideas within the equivalent scope should be interpreted as being included in the scope of rights of the present embodiment.

### CROSS-REFERENCE TO RELATED APPLICATION

This patent application claims priority to Korean Patent Application No. 10-2022-0013749, filed on Jan. 28, 2022, which is incorporated herein by reference in its entirety.

### DESCRIPTION OF REFERENCE NUMERALS

100: real estate automatic trading device 110: sell order receiving unit
120: order price receiving unit 130: order execution unit
140: confirmation selection receiving unit 210: order server
211: terminal interface 212: listing registration module
213: order reception module 214: execution approval module
220: execution server 220a, 220b, 220c: execution unit
221: order price reception module 222: order price transmission module
223: order price aggregation module 224: execution module
225: execution confirmation module 226: executions history transmission module
230: price server 231: listing information management module
232: listing information transmission module 233: order price reception module
234: executions history reception module 235: price transmission module
236: order price aggregation module 237: execution aggregation module
240: certified real estate agent terminal 250: seller terminal
260: buyer terminal

1. A real estate automatic trading device comprising:
a sell order receiving unit configured to receive a sell order for a target real estate including a selection of one of order execution rules of the target real estate from a seller terminal;
an order price receiving unit configured to receive a plurality of ask prices from a plurality of sale proposal terminals for the target real estate based on the selected order execution rule, receive a plurality of bid prices from a plurality of buyer terminals wishing to purchase the target real estate, and store the plurality of ask prices and the plurality of bid prices as an order price for the target real estate; and
an order execution unit configured to generate order execution information including an order execution counterparty and an order execution price for the target real estate based on the plurality of ask prices and the plurality of bid prices.

2. The real estate automatic trading device of claim 1, wherein the order price receiving unit performs a suitability verification based on an upper/lower price limit range set for the target real estate compared to a reference price for at least one of the ask price and the bid price.

3. The real estate automatic trading device of claim 2, wherein the reference price is determined based on an actual transaction price for the target real estate during a predetermined period, and if there is no actual transaction price for the predetermined period, the reference price is determined based on a previous order price for the target real estate.

4. The real estate automatic trading device of claim 3, wherein the reference price is determined as a higher price of a highest bid price and a lowest ask price within the previous order prices.

5. The real estate automatic trading device of claim 1, wherein if the selected order execution rule is that the transaction is concluded based on an order price designated by the seller terminal, in the sell order receiving unit, whether a revised ask price for the target real estate is to be calculated by the real estate automatic trading device is determined by the seller terminal.

6. The real estate automatic trading device of claim 5, wherein the order execution unit calculates the revised ask price by taking weighted average of a previous actual transaction price of the target real estate and the ask price.

7. The real estate automatic trading device of claim 6, wherein the sell order receiving unit provides the seller terminal with a function to select whether the revised ask price for the target real estate is to be calculated by the real estate automatic trading device based on the order price.

8. A method of executing real estate automatic trading by a real estate automatic trading device, the method comprising:
receiving a sell order for a target real estate including a selection of one of order execution rules of the target real estate from a seller terminal;
receiving a plurality of ask prices from a plurality of sale proposal terminals for the target real estate according to the selected order execution rule, receiving a plurality of bid prices from a plurality of buyer terminals wishing to purchase the target real estate, and storing the plurality of ask prices and the plurality of bid prices as an order price for the target real estate; and
generating order execution information including an order execution counterparty and an order execution price for the target real estate based on the plurality of ask prices and the plurality of bid prices.
